(19) United States
(12) Patent Application Publication
(10) Pub. No.: US 2018/0232747 A1
(43) Pub. Date: Aug. 16, 2018

(54) SYSTEMS AND METHODS FOR DETERMINING CONSUMER PURCHASING BEHAVIOR

(71) Applicant: Capital One Services, LLC, McLean, VA (US)

(72) Inventors: Andrew Wen, Palo Alto, CA (US); James Patterson, Washington, DC (US)

(73) Assignee: Capital One Services, LLC, McLean, VA (US)

(21) Appl. No.: 15/952,640

(22) Filed: Apr. 13, 2018

Related U.S. Application Data
(62) Division of application No. 14/097,464, filed on Dec. 5, 2013.
(60) Provisional application No. 61/734,823, filed on Dec. 7, 2012.

(51) Int. Cl. G06Q 30/02; G06Q 30/06

(52) U.S. Cl. CPC G06Q 30/0201; G06Q 30/06

(57) ABSTRACT

Systems and methods are disclosed for analyzing and predicting spending behaviors of consumers. A financial service system configures a financial service account for a user associated with a merchant. The financial service system, after receiving notification of purchase transactions made by the user with the account, may collect information relating to the transactions. The financial service system may determine other merchants that “co-occur” with the first merchant—in other words, where else are the first merchant's customers shopping and who are their true competitors? The financial service system may then compile this data and provide it to the merchant, who may modify their business practices based on the information.

### CROSS REFERENCE TO RELATED APPLICATION

This application claims priority under 35 U.S.C. § 119 to U.S. Provisional Application No. 61/734,823, filed on Dec. 7, 2012, which is expressly incorporated herein by reference in its entirety.

### FIELD

The disclosed embodiments generally relate to analyzing and predicting customer purchasing behavior, particularly providing information to retailers about the purchasing behavior of their customers.

### BACKGROUND

One of the best ways for a retailer to increase sales is to learn more about their customer base, in order to know better what products and incentives to offer them. An important piece of information to know is where else, besides the retailer, that a customer is shopping. Finding out a retailer's “true” competition in this manner can be very educational for a retailer's marketing department, as a retailer's perception of its competitors often does not match reality. As an example, a luxury clothing merchant may believe that it competes for its customers' business only with other luxury clothiers, when in reality those customers are actually spending their money at high-end car dealerships, sommeliers, and spas. Expanding the notion of the marketplace in this manner can make a critical impact in when, where, and how a retailer offers and advertises its goods and services.

Many current methods for discovering co-occurrence of retailers among customers are expensive, labor intensive, or unreliable. Surveying customers may not always yield accurate data, and trying to decipher customer lists from the retailer side may be too difficult. The common thread among them all is the method of payment that the customers use to complete the purchase transaction with the retailer. As credit cards, debit cards, and other forms of electronic payment have become ubiquitous in modern commerce, it has become possible to log and reference customer purchasing behavior. Financial service providers that issue these payment cards can now offer a wealth of data and information to retailers and advertisers that goes beyond just when and where a customer shopped.

Accordingly, there is a need to provide more relevant and comprehensive data to retailers related to other retailers that co-occur among their customer base.

### SUMMARY

Methods and systems consistent with the present disclosure enable a computing system to receive transaction information relating to a first purchase transaction made by a user using an account provided by a financial service provider. Based on the received first transaction information, the computing system may identify a first merchant associated with the first purchase transaction. Additionally, the computing system may receive second transaction information relating to at least one additional purchase transaction made by the user using the financial service account. Based on the received second transaction information, the computing system may identify at least one other merchant associated with the at least one additional purchase transaction. Further, the computing system may generate a report for the first merchant based on the received second transaction information, wherein the report comprises a list of co-occurring merchants and co-occurrence scores for each of the co-occurring merchants on the list, and then provide the report to the first merchant.

In another embodiment, a method is disclosed for determining the purchasing behavior of a customer. The method includes receiving, via one or more processors, first transaction information relating to a first purchase transaction made by a user using an account provided by a financial service provider. Further, the method includes identifying, based on the received first transaction information, a first merchant associated with the first purchase transaction. The method also includes receiving, via the one or more processors, second transaction information relating to at least one additional purchase transaction made by the user using the financial service account. Additionally, the method includes identifying at least one other merchant associated with the at least one additional purchase transaction. Further, the method includes generating, via the one or more processors, a report for the first merchant based on the received second transaction information comprising a list of co-occurring merchants and co-occurrence scores for each of the co-occurring merchants on the list, as well as providing the report to the first merchant.

In yet another embodiment, a method is disclosed for determining the purchasing behavior of a customer. The method includes transmitting, via one or more processors, first transaction information to a financial service system relating to a first purchase made by a user using an account provided by the financial service system. Further, the method includes receiving, via the one or more processors, information from the financial service system comprising the identity of at least one other merchant associated with at least one additional purchase transaction made by the user based on second transaction information. The method additionally includes modifying one or more business practices based on the information received from the financial service system, and monitoring sales subsequent to the business practice modification.

Additional objects and advantages of the disclosed embodiments will be set forth in part in the description which follows, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed. For example, the methods relating to the disclosed embodiments may be implemented in system environments outside of the exemplary system environments disclosed herein.

### BRIEF DESCRIPTION OF THE DRAWINGS

The accompanying drawings, which are incorporated in and constitute a part of this specification, illustrate various embodiments and aspects of the disclosed embodiments and, together with the description, serve to explain the principles of the disclosed embodiments. In the drawings:

FIG. 1 illustrates an exemplary system consistent with disclosed embodiments;

FIG. 2 is a flowchart of an exemplary consumer information gathering process consistent with disclosed embodiments;

FIG. 3 is a flowchart of an exemplary co-occurrence determination process consistent with disclosed embodiments;

FIG. 4 is a flowchart of an exemplary co-occurrence reporting process consistent with disclosed embodiments; and

FIG. 5 is a flowchart of an exemplary retailer consumer targeting process consistent with disclosed embodiments.

### DETAILED DESCRIPTION

Reference will now be made in detail to disclosed embodiments, examples of which are illustrated in the accompanying drawings. Wherever convenient, the same reference numbers will be used throughout the drawings to refer to the same or like parts.

Generally, the disclosed embodiments are directed to systems and methods for determining the purchasing behavior of consumers. Further, steps or processes disclosed herein are not limited to being performed in the order described, but may be performed in any order, and some steps may be omitted, consistent with the disclosed embodiments.

The features and other aspects and principles of the disclosed embodiments may be implemented in various environments. Such environments and related applications may be specifically constructed for performing the various processes and operations of the disclosed embodiments or they may include a general purpose computer or computing platform selectively activated or reconfigured by program code to provide the necessary functionality. The processes disclosed herein may be implemented by a suitable combination of hardware, software, and/or firmware. For example, the disclosed embodiments may implement general purpose machines that may be configured to execute software programs that perform processes consistent with the disclosed embodiments. Alternatively, the disclosed embodiments may implement a specialized apparatus or system configured to execute software programs that perform processes consistent with the disclosed embodiments.

The disclosed embodiments also relate to tangible and non-transitory computer readable media that include program instructions or program code that, when executed by one or more processors, perform one or more computer-implemented operations. For example, the disclosed embodiments may execute high level and/or low level software instructions, such as machine code (e.g., such as that produced by a compiler) and/or high level code that can be executed by a processor using an interpreter.

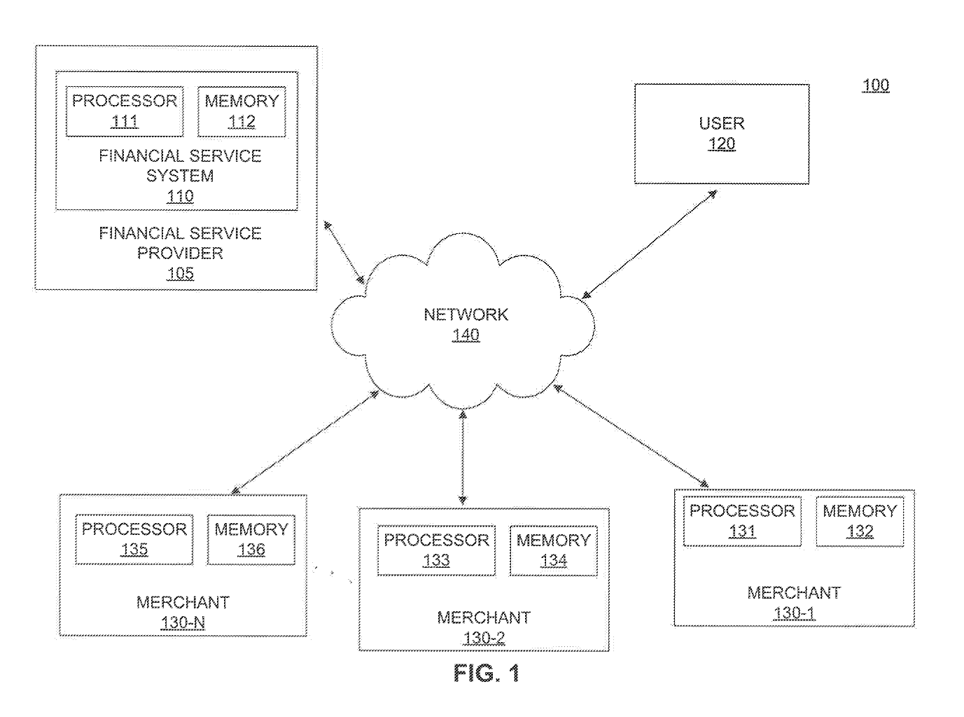

FIG. 1 illustrates an exemplary system 100 consistent with disclosed embodiments. In one aspect, system 100 may include a financial service provider 105, financial service system 110, user 120, various merchant systems 130-1 through 130-N, and network 140.

Financial service provider 105 may be one or more entities that configure, offer, provide, and/or manage financial service accounts, such as credit card accounts, debit card accounts, checking or savings accounts, and loan accounts. In one aspect, financial service provider 105 may include or is associated with financial service system 110 that may be configured to perform one or more aspects of the disclosed embodiments. In some embodiments, financial service system 110 may receive and process payments from consumers such as user 120, relating to one or more financial service accounts provided by financial service provider 105 associated with financial service system 110.

Financial service system 110 may include one or more components that perform processes consistent with the disclosed embodiments. For example, financial service system 110 may include one or more computers (e.g., servers, database systems, etc.) configured to execute software instructions programmed to perform aspects of the disclosed embodiments, such as generating financial service accounts and/or loan accounts, maintaining accounts, processing information relating to accounts, etc. Consistent with disclosed embodiments, financial service system 110 may include other components and infrastructure that enable it to perform operations, processes, and services consistent with financial service account providers, such as banking operations, credit card operations, loan operations, etc. Consistent with disclosed embodiments, financial service system 110 may be configured to analyze past behavior of user or users 120 associated with merchants 130, and predict future spending behaviors of user or users 120.

User 120 may be one or more customers or prospective customers of financial service provider 105 and/or merchants 130. User 120 may be an individual, a group of individuals, a business entity, or a group of business entities. Although the description of certain embodiments may refer to an “individual,” the description applies to a group of users or a business entity. In certain aspects, user 120 may include one or more computing devices that is associated with (e.g., used by) user 120 to perform computing activities, such as a laptop, desktop computer, tablet device, smart phone, or other handheld or stand-alone devices configured to execute software instructions and communicate with network 140 or other components of system environment 100. For example, user 120 may use a handheld device to communicate with financial service system 110 or merchants 130 over the Internet. Reference to user 120 in terms of processes consistent with certain disclosed embodiments may relate to functionalities performed by the user's computing device.

Merchants 130-1, 130-2, 130-N, etc. may represent one or more entities that provide goods and/or services that may be purchased by consumers, such as user 120. For example, merchants 130 may represent a vendor that offers goods or services user 120 purchases using one or more of the financial service accounts held by the user and provided by financial service system 110 or merchants 130. User 120 may purchase goods and/or services from merchants 130 directly over normal channels of trade (i.e., a point of sale (POS) purchase), or they may purchase them from merchants 130 over network 140 (i.e. telephonically or “online” via the Internet).

Merchants 130 may each include one or more components that perform processes consistent with the disclosed embodiments. For example, merchants 130 may each include one or more computers (e.g., servers, database systems, etc.) that are configured to execute software instructions programmed to perform aspects of the disclosed embodiments and known financial service account processes, such as generating financial service accounts, maintaining such accounts, processing information relating to such accounts, processing and handling transactions relating to sales of goods and/or services, etc. One of ordinary skill in the art would recognize that merchants 130 may each include components and infrastructure that enable them to perform operations, processes, and services consistent with merchants, such as providing websites that offer for sale goods and/or services, processing sales transactions of purchases made over the Internet or at POS locations, and communicating with financial service system 110 or other components relating to the transactions.

Consistent with disclosed embodiments, components of system 100, including financial service system 110 and merchants 130, may include one or more processors (such as processors 111, 131, 133, or 135) as shown in exemplary form in FIG. 1. The processors may be one or more known processing devices, such as a microprocessor from the Pentium™ family manufactured by Intel™ or the Turion™ family manufactured by AMD™. The processor may include a single core or multiple core processor system that provides the ability to perform parallel processes simultaneously. For example, the processors may be single core processors configured with virtual processing technologies known to those skilled in the art. In certain embodiments, the processors may use logical processors to simultaneously execute and control multiple processes. The processors may implement virtual machine technologies, or other similar known technologies to provide the ability to execute, control, run, manipulate, store, etc. multiple software processes, applications, programs, etc. In some embodiments, the processors may include a multiple-core processor arrangements (e.g., dual or quad core) configured to provide parallel processing functionalities to enable computer components of financial service system 110 and/or merchants 130 to execute multiple processes simultaneously. Other types of processor arrangements could be implemented that provide for the capabilities disclosed herein. Moreover, the processors may represent one or more servers or other computing devices that are associated with financial service system 110 and/or merchants 130. For instance, the processors may represent a distributed network of processors configured to operate together over a local or wide area network. Alternatively, the processors may be a processing device configured to execute software instructions that receive and send information, instructions, etc. to/from other processing devices associated with financial service system 110 or other components of system 100. In certain aspects, processors 111, 131, 133 and/or 135 may be configured to execute software instructions stored in memory to perform one or more processes consistent with disclosed embodiments.

Consistent with disclosed embodiments, components of system 100, including financial service system 110 and merchants 130, may also include one or more memory devices (such as memories 112, 132, 134, and 136) as shown in exemplary form in FIG. 1. The memory devices may store software instructions that are executed by processors 111, 131, 133, and/or 135, such as instructions associated with one or more applications, network communication processes, operating system software, software instructions relating to the disclosed embodiments, and any other type of application or software known to be executable by processing devices. The memory devices may be volatile or non-volatile, magnetic, semiconductor, tape, optical, removable, nonremovable, or other types of storage devices or tangible computer-readable media. The memory devices may be two or more memory devices distributed over a local or wide area network, or may be a single memory device. In disclosed embodiments, the memory devices may include database systems, such as database storage devices, configured to receive instructions to access, process, and send information stored in the storage devices.

In some embodiments, financial service system 110, user 120, and merchants 130 may also include one or more additional components (not shown) that provide communications with other components of system environment 100, such as through network 140, or any other suitable communications infrastructure.

Network 140 may be any type of network that facilitates communications and data transfer between components of system environment 100, such as, for example, financial service system 110, user 120, and merchants 130. Network 140 may be a Local Area Network (LAN), a Wide Area Network (WAN), such as the Internet, and may be a single network or a combination of networks. Further, network 140 may reflect a single type of network or a combination of different types of networks, such as the Internet and public exchange networks for wireline and/or wireless communications. Network 140 may utilize cloud computing technologies. Moreover, any part of network 140 may be implemented through infrastructures or channels of trade to permit operations associated with financial accounts that are performed manually or in-person by the various entities illustrated in FIG. 1. Network 140 is not limited to the above examples and system 100 may implement any type of network that allows the entities (and others not shown) included in FIG. 1 to exchange data and information.

Although FIG. 1 describes a certain number of entities and processing/computing components within system 100, any number or combination of components may be implemented without departing from the scope of the disclosed embodiments. For example, different users 120 may interact with one or more merchants 130 through network 140 or standard channels of trade, such as face-to-face purchase transactions. In another example, different financial service systems 110 may interact with one or more users 120 and merchants 130 through network 140 or standard channels of trade. Additionally, financial service system 110 and merchants 130 are not mutually exclusive. For example, in one disclosed embodiment, financial service system 110 and one or more merchants 130 may be the same entity. Merchants 130 are not mutually exclusive; for example, merchant 130-1 and merchant 130-2 may be the same entity, different locations of the same entity, POS aspects and Internet aspects of the same entity, subsidiaries of the same entity, or a parent entity and its subsidiary. Thus, the entities as described are not limited to their discrete descriptions above. Further, where different components of system environment 100 are combined (e.g., merchant 130-1 and merchant 130-2, etc.), the computing and processing devices and software executed by these components may be integrated into a local or distributed system.

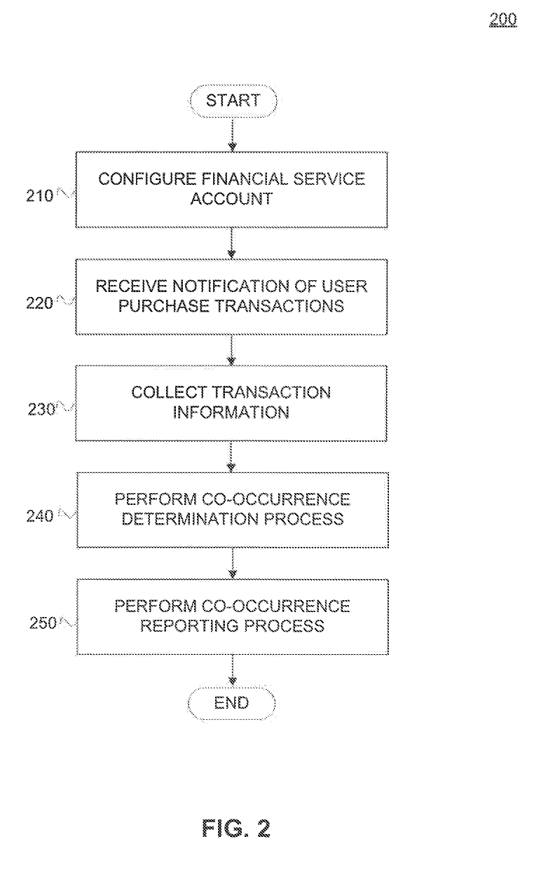

FIG. 2 illustrates an exemplary consumer information gathering process consistent with disclosed embodiments. Consumer information gathering process 200, as well as any or all of the individual steps therein, may be performed by any one or more of financial service system 110, or merchants 130. For exemplary purposes, FIG. 2 is disclosed as being performed by financial service system 110.

Financial service system 110 may configure a financial service account for user 120 associated with merchant 130-1 (Step 210). In one aspect, financial service system 110 may configure the financial service account for user 120 as a credit card account solely associated with merchant 130-1 and only usable at POS locations of merchant 130-1 or online at merchant 130-1's website. In one aspect, financial service system 110 may configure the financial service account for user 120 as a credit card account associated with merchant 130-1 but usable at other merchants, such as merchants 130-2 through 130-N. In another aspect, financial service system 110 may configure the financial service account for user 120 as a credit card account not specifically associated with any particular merchant 130. In another aspect, financial service system 110 may configure the financial service account for user 120 as a rewards or loyalty card account associated with merchant 130-1.

Financial service system 110 may receive a notification that user 120 has completed a purchase transaction or transactions using the financial service account associated with merchant 130-1 (Step 220). The notification may occur instantaneously with the purchase transactions, or it may occur at a later time (e.g., automatic periodic reports, responses to requests from financial service system 110, etc.). Financial service system 110 may receive the notification directly from merchant 130-1 via postal mail or telephonic means, or may receive it via network 140 or any other well-known means of communication.

Financial service system 110 may acquire, collect, and store information about the purchase transaction or transactions (Step 230). In one aspect, merchant 130-1 may provide the transaction information to financial service system 110 in response to a request by financial service system 110 or automatically based on periodic reporting mechanisms. The transaction information may include data about user 120, such as demographic information, value of transaction, types of goods purchased, consumer history with merchant 130-1 or other merchants, etc. The transaction information may also include information or data about the consumer, merchant, transaction, or financial account. In one aspect, merchant 130-1 may provide the transaction information to an external database for storage and access by financial service system 110, or alternatively, directly transmit the information to financial service system 110 via network 140. The processes and mechanisms used for collecting transaction information are exemplary and the disclosed embodiments are not limited to the above examples. Financial service system 110, and merchant 130-1 may each be configured to collect, store, and monitor transaction information using other types of technologies, methodologies, and processes familiar to those skilled in the art.

Financial service system 110 may use the information received from merchant 130-1 to perform a co-occurrence determination process (Step 240) and a co-occurrence reporting process (Step 250), which will each be described in further detail below.

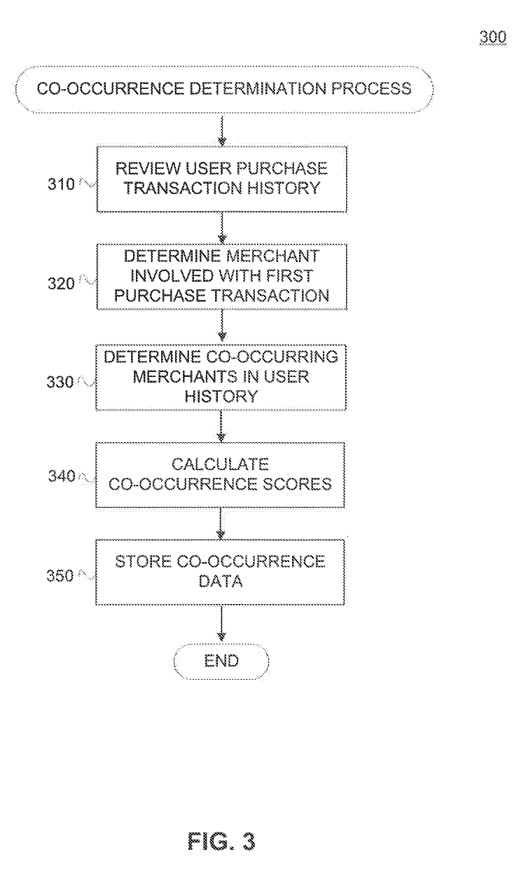

FIG. 3 illustrates an exemplary co-occurrence determination process, consistent with disclosed embodiments. Co-occurrence determination process 300, as well as any or all of the individual steps therein, may be performed by any one or more of financial service system 110, or various merchants 130. For exemplary purposes, FIG. 3 is disclosed as being performed by financial service system 110.

Financial service system 110 may review purchase transaction history for user 120 associated with the financial service account configured in Step 210 (Step 310). Financial service system 110 may review the purchase transaction history in-house, or may review it remotely over network 140. The purchase transaction history may include various details about previous purchase transactions, such as identifying information about the merchants 130 associated with the sale, the date and time of the purchase transactions, the location (POS or remote) where the purchase transaction was made, the currency value of the purchase transaction, the item or items purchased in the purchase transaction, etc. This list of information contained in the purchase transaction history is not intended to be limiting to the disclosed embodiments and financial service system 110 may review more or less information in a given instance. Financial service system 110 may determine a merchant involved with a first purchase transaction (Step 320). For exemplary purposes, the purchase transaction is associated with merchant 130-1. In making the determination, financial service system 110 may determine other information about merchant 130-1, such as corporate structure, location, general business information, inventory, holding status, headquarters location, etc. It is to be understood that this list of information is not intended to be limiting and financial service system 110 may review more or less information about merchant 130-1 in a given instance. Financial service system 110 may perform the determination of Step 320 in response to an inquiry by merchant 130-1, or may perform the determination spontaneously. The first purchase transaction need not occur chronologically first or at any specific time. The first purchase transaction may meet certain predefined criteria set forth by one or both of financial service system 110 and merchant 130-1, such as meeting a threshold value, etc. The determination of Step 320 may be made for any number of users 120 for which financial service system 110 has configured financial service accounts associated with merchant 130-1. The determination may be made for as few as one user 120, up to and including all users 120 for which financial service system 110 has configured financial service accounts.

Financial service system 110 may determine a set of co-occurring merchants in the user purchase transaction history (Step 330). The determination may be made for any number of users 120 for which financial service system 110 has configured financial service accounts associated with merchant 130-1. The determination may be made for as few as one user 120, up to and including all users 120 for which financial service system 110 has configured financial service accounts. For exemplary purposes, the co-occurring merchants are merchants 130-2 through 130-N. Financial service system 110 may determine the list of co-occurring merchants based on pre-defined criteria, such as all transactions made by user or users 120 within a set period of time, or above or below a certain value. The determination may be based on geographical factors, such as within a neighborhood, city, state, region, nation, continent, or worldwide, or may be based on demographic factors such as the race, age, income, marital status, etc. of the user or users 120 associated with the purchase transactions.

Financial service system 110 may determine a co-occurrence score for one or more of the merchants 130-2 through 130-N found to co-occur with merchant 130-1 (Step 340). A co-occurrence score may reflect how frequently the customers of one merchant are also customers of another merchant. This score associating two merchants can provide advice on the identification of competitors for merchants in the same retail category as well as potential marketing partners for merchants in different retail categories. In one aspect, financial service system 110 may calculate the eligibility score for buyer system 130 based on the extent to which buyer system 130 and the purchase transaction information meet or exceed the predetermined criteria of Step 320. Financial service system 110 may use any information associated with members of system environment 100 and the purchase transaction completed by user or users 120 to determine the co-occurrence score.

In one embodiment, the co-occurrence score may be calculated by taking the number of customers who have completed purchase transactions at both merchants (intersection set) divided by the total number of customers for both merchants (union set). The result is a numerical score between 0 and 1. A score of 0 indicates no intersecting customer. A score of 1 indicates a complete overlap of customers. A score of 0.5 indicates half of each merchants customers are in common with each other.

Once calculated, financial service system 110 may store the co-occurrence data, including the list of co-occurring merchants and their corresponding co-occurrence scores, if calculated (Step 350). Financial service system 110 may store the co-occurrence data in memory 112, another memory device local to financial service system 110, or within another memory device.

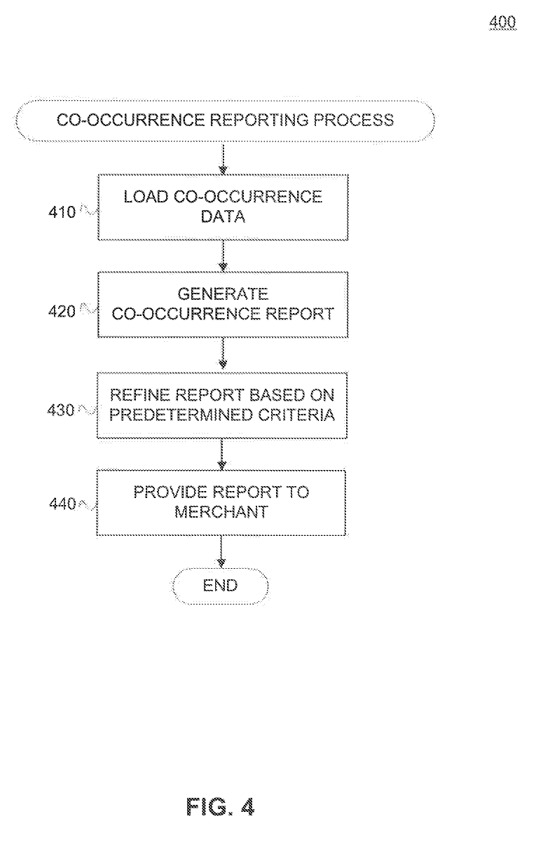

FIG. 4 illustrates a flowchart of an exemplary co-occurrence reporting process 400 consistent with certain disclosed embodiments. Co-occurrence reporting process 400, as well as any or all of the individual steps therein, may be performed by any one or more of financial service system 110 or merchant 130-1. For exemplary purposes, FIG. 4 is disclosed as being performed by financial service system 110.

Financial service system 110, potentially via processor 111, may load co-occurrence data (Step 410). In one aspect, the co-occurrence data may be newly gathered via co-occurrence determination process 300, or it may be data gathered at another time. In certain embodiments, financial service system 110 may load the co-occurrence data from memory 112, or load it via network 140.

Financial service system 110 may generate a co-occurrence report (Step 420). In one aspect, the co-occurrence report may comprise the list of co-occurring merchants to merchant 130-1, such as merchants 130-2 through 130-N. In another aspect, the co-occurrence report may comprise co-occurrence scores calculated for merchants 130-2 through 130-N, for example, as calculated in Step 340 of co-occurrence determination process 300. In yet another aspect, the co-occurrence report may comprise both the list of co-occurring merchants and their corresponding co-occurrence scores. It may be appreciated by one skilled in the art that financial service system 110 may generate a report with more or less information in a given circumstance for a given merchant 130-1.

Financial service system 110 may refine the co-occurrence report based on predetermined criteria (Step 430). The predetermined criteria may be determined by financial service system 110, merchant 130-1, or determined by both entities in conjunction with one another. The predetermined criteria may be, for example, a limitation on the range of dates comprising the report. The report may, for example, be generated on an hourly, daily, weekly, monthly, quarterly, yearly, or on a fiscal year basis. The predetermined criteria may be based on geography; for example, the report may provide information on merchant co-occurrence between merchant 130-1 and other merchants competing in market X, where X may be, for example, a neighborhood, city, state, region, nation, continent, or worldwide. The predetermined criteria may be based on information collected about users 120, such as demographic information comprising the age, gender, income, marital status, etc. of users 120. It is to be understood that this list of predetermined criteria is exemplary and not intended to be limiting. One skilled in the art could conceive of many criteria that could assist financial service system 110 in refining the co-occurrence report.

Financial service system 110 may also execute software instructions via processor 111 and memory 112 to provide the report to merchant 130-1 (Step 440). In one embodiment, financial service system 110 may provide the report to merchant 130-1 via network 140, an external database, or directly via other communication mechanisms. Financial service system 110 may provide the report one time to merchant 130-1, or may provide the reports on a repeating basis, for example, hourly, daily, weekly, monthly, quarterly, yearly, or on a fiscal year basis. Financial service system 110 may provide the report gratis or may provide it for a fee. A fee collected for providing the report may be a one-time fee, or may be part of a subscription business model where various merchants 130 pay financial service system 110 to provide the reports. The reports may also be provided by financial service system 110 as part of a bundle of services offered to merchant 130-1.

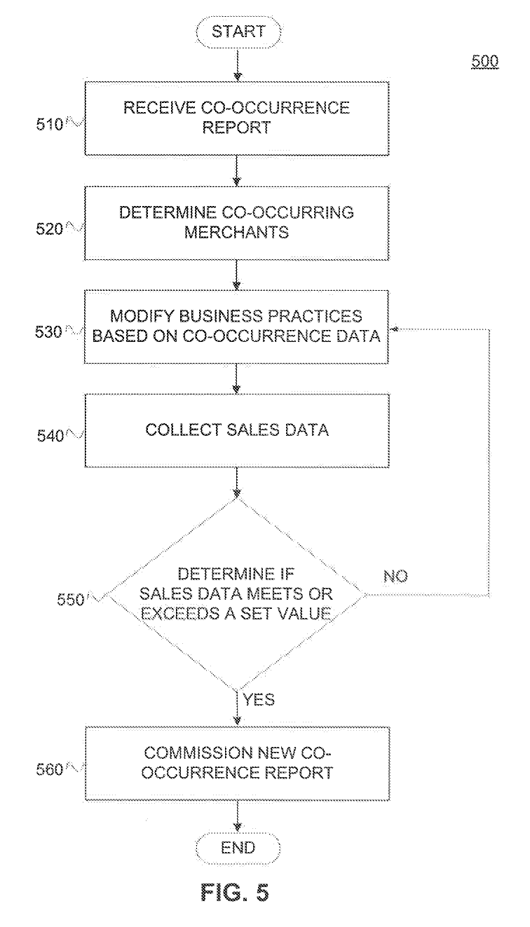

FIG. 5 illustrates a flowchart of an exemplary retailer consumer targeting process 500 consistent with certain disclosed embodiments. Retailer consumer targeting process 500, as well as any or all of the individual steps therein, may be performed by any one or more of financial service system 110 or merchant 130-1. For exemplary purposes, FIG. 5 is disclosed as being performed by merchant 130-1.

In one embodiment, the system of merchant 130-1 may be configured to receive a co-occurrence report (Step 510). For exemplary purposes, the report is received from financial service system 110. The co-occurrence report may be compiled, transmitted, and received by merchant 130-1 for one or more users 120 as relevant purchase transactions are completed, or it may be done at set time intervals, including but not limited to hourly, daily, weekly, monthly, quarterly, yearly, or on a fiscal year basis. The co-occurrence report may, for example, contain information about other co-occurring merchants. The co-occurrence report may contain co-occurrence scores calculated by financial service system 110. Processor 131 may be configured to receive the offer redemption data over interface components at merchant 130-1 that connect to network 140. Alternatively, merchant 130-1 may receive the offer redemption data via other known means of communication, such as postal mail, telephonic means, SMS messaging, or via a mobile application, and provide the data for processing by processor 131.

Merchant 130-1 may determine other merchants that co-occur with its customer base (Step 520). Merchant 130-1 may make the determination on the basis of co-occurrence scores exceeding a set value, or it may make the determination based on other grounds or other evidence contained within the co-occurrence report.

In response to the list of co-occurring merchants, merchant 130-1 may modify its business practices in some way based on the co-occurrence data (Step 530). The modification may include a wide range of activities relevant to the goals of merchant 130-1 and the nature of its business. For example, merchant 130-1 may change its stock on hand and inventory based on merchants 130-2 through 130-N that it determines co-occur with its consumer base. Merchant 130-1 may generate a targeted communication to its customer base to encourage loyalty to merchant 130-1. For example, merchant 130-1 may issue user or users 120 targeted advertising for items in its inventory that correspond with items found in the inventories of merchants 130-2 through 130-N. Merchant 130-1 may issue user or users 120 a coupon directed towards items found in the inventories of merchants 130-2 through 130-N. Merchant 130-1 may issue user or users 120 a card-linked offer linked to the financial service account configured for user or users 120 by financial service system 110. It is to be understood that these modifications are exemplary, and the list is not intended to be limiting. One skilled in the art may conceive of a multitude of business modifications that merchant 130-1 may make using co-occurrence data.

Merchant 130-1 may collect sales data following modification of its business practices (Step 540). Merchant 130-1 may collect the data at various points in time, including but not limited to hourly, daily, weekly, monthly, quarterly, yearly, or on a fiscal year basis. Merchant 130-1 may receive sales data from financial service system 110. Merchant 130-1 may collect the data itself using telephonic or postal means, or via network 140. The sales data may be stored in memory 132 or in another memory device configured for merchant 130-1. The sales data may be for merchant 130-1's entire business, or it may be targeted to a subset of items sold from within its inventory. For example, the sales data collected in Step 540 may correspond to the subset of items in merchant 130-1's inventory that overlaps with the items in the inventories of merchants 130-2 through 130-N.

Merchant 130-1 may determine if the sales data collected in Step 540 meets or exceeds a set value forecast for the sales data (Step 550). If the sales data does not meet or exceed the set value (Step 550: NO), retailer consumer targeting process 500 may revert back to Step 530, wherein merchant 130-1 may repeat the business practice modifications made previously, or may choose to enact a different set of modifications. Subsequently, merchant 130-1 may collect sales data once again and re-evaluate the success of business practice modifications.

If the sales data does meet or exceed the set value (Step 550: YES), then merchant 130 may opt to commission a new co-occurrence report (Step 560). Step 560 may occur naturally in the course of merchant 130-1's business, such as after a set period of time, or it may occur in response to achieving other business goals. Merchant 130-1 may commission a new co-occurrence report from financial service system 110. The new co-occurrence report may be compiled based on the same parameters as the initial report, or it may be based on different parameters.

Other features and functionalities of the described embodiments are possible. For example, the processes of FIGS. 2-5 are not limited to the sequences described above. Variations of these sequences, such as the removal and/or the addition of other process steps may be implemented without departing from the spirit and scope of the disclosed embodiments.

Additionally, any financial institution that provides credit card accounts to customers may employ systems, methods, and articles of manufacture consistent with certain principles related to the disclosed embodiments. In addition, any merchant may also employ systems, methods, and articles of manufacture consistent with certain disclosed embodiments.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

1-20. (canceled)

21. A system for business practice modification, comprising:
one or more storage devices storing instructions; and
one or more processors configured to execute the instructions to perform operations comprising:
transmitting first transaction information to a financial service system, the first transaction information relating to a first purchase from a first merchant made by a user using an account provided by the financial service system;
receiving information from the financial service system, the received information comprising an identity of a second merchant associated with a second purchase made by the user and a list of co-occurring merchants determined by the financial service system based on at least one of: geographic locations of the first merchant and the second merchant, demographic information associated with the user, or currency values of the first and second purchase transactions;
reporting the information received from the financial service system to facilitate making first modifications to a business practice, the first modifications being determined based on identities of the first and second merchants and the list of co-occurring merchants;
storing sales data collected subsequent to the business practice modification;
comparing the stored sales data to forecasted sales data; and
reporting the comparison of the stored sales data to forecasted sales data to facilitate making second modifications to the business practice, the second modifications being determined based on the comparison.

22. The system of claim 21, wherein making the first modifications comprises:
changing items in inventory based on identities of the first merchant and the second merchant.

23. The system of claim 21, wherein making the first modifications comprises:
changing stock on hand based on identities of the first merchant and the additional merchant.

24. The system of claim 21, wherein making the first modifications comprises:
generating targeted communications to customers, based on identities of the first and second merchants.

25. The system of claim 24, wherein the targeted communications comprise a discount offer for an item found in inventory of both the first and second merchants.

26. The system of claim 24, wherein the targeted communications comprise at least one of a coupon or a card-linked offer linked to an account provided by the financial service system.

27. The system of claim 21, wherein the sales data comprises multiple sets of sales data collected subsequent to the business practice modification.

28. The system of claim 21, wherein:
making the second modifications comprises determining that the stored sales data is less than the forecasted sales data;
the second modifications are different from the first modifications; and
the second modifications are determined based at least partially on identities of the first and second merchants.

29. A computer-implemented method for modifying business practices, comprising:
transmitting first transaction information to a financial service system, the first transaction information relating to a first purchase from a first merchant made by a user using an account provided by the financial service system;
receiving information from the financial service system, the received information comprising an identity of a second merchant associated with a second purchase made by the user and a list of co-occurring merchants determined by the financial service system based on at least one of: geographic locations of the first merchant and the second merchant, demographic information associated with the user, or currency values of the first and second purchase transactions;
reporting the information received from the financial service system to facilitate making, by at least one processor, first modifications to a business practice, the first modifications being determined based on identities of the first and second merchants and the list of co-occurring merchants;
storing, on at least one storage device, sales data collected subsequent to the business practice modification;
comparing, by the at least one processor, the stored sales data to forecasted sales data; and
reporting the comparison of the stored sales data to forecasted sales data to facilitate making, by the at least one processor, second modifications to the business practice, the second modifications being determined based on the comparison.

30. The method of claim 29, wherein making the first modifications comprises:
changing items in inventory based on identities of the first merchant and the second merchant.

31. The method of claim 29, wherein making the first modifications comprises:
changing stock on hand based on identities of the first merchant and the additional merchant.

32. The method of claim 29, wherein making the first modifications comprises:
generating targeted communications to customers, based on identities of the first and second merchants.

33. The method of claim 32, wherein the targeted communications comprise a discount offer for an item found in inventory of both the first and second merchants.

34. The method of claim 32, wherein the targeted communications comprise at least one of a coupon or a card-linked offer linked to an account provided by the financial service system.

35. The method of claim 29, wherein the sales data comprises multiple sets of sales data collected subsequent to the business practice modification.

36. The method of claim 29, wherein:
making the second modifications comprises determining that the stored sales data is less than the forecasted sales data;
the second modifications are different from the first modifications; and
the second modifications are determined based at least partially on identities of the first and second merchants.

37. A tangible non-transitory computer-readable medium storing instructions which, when executed by a processor, perform operations for modifying business practices, comprising:
transmitting first transaction information to a financial service system, the first transaction information relating to a first purchase from a first merchant made by a user using an account provided by the financial service system;
receiving information from the financial service system, the received information comprising an identity of a second merchant associated with a second purchase made by the user and a list of co-occurring merchants determined by the financial service system based on at least one of: geographic locations of the first merchant and the second merchant, demographic information associated with the user, or currency values of the first and second purchase transactions;
reporting the information received from the financial service system to facilitate making first modifications to a business practice, the first modifications being determined based on identities of the first and second merchants and the list of co-occurring merchants;
storing sales data collected subsequent to the business practice modification;
comparing, by the at least one processor, the stored sales data to forecasted sales data; and
reporting the comparison of the stored sales data to forecasted sales data to facilitate making second modifications to the business practice, the second modifications being determined based on the comparison.

38. The medium of claim 37, wherein making first modifications comprises at least one of:
changing items in inventory based on identities of the first merchant and the second merchant;
changing stock on hand based on identities of the first merchant and the additional merchant; or
generating targeted communications to customers, the targeted communications being generated based on identities of the first and second merchants.

39. The medium of claim 37, wherein the sales data comprises multiple sets of sales data collected subsequent to the business practice modification.

40. The medium of claim 37, wherein:
making the second modifications comprises determining that the stored sales data is less than the forecast for the sales data;
the second modifications are different from the first modifications; and
the second modifications are determined based at least partially on identities of the first and second merchants.
